(19) United States
(12) Patent Application Publication
(10) Pub. No.: US 2016/0276713 A1
(43) Pub. Date: Sep. 22, 2016

(54) LAMINATED SECONDARY BATTERY

(71) Applicant: Murata Manufacturing Co., Ltd., Nagaokakyo-shi (JP)

(72) Inventors: Hirotaka Maeyoshi, Nagaokakyo-shi (JP); Daisuke Otsuka, Nagaokakyo-shi (JP)

(21) Appl. No.: 15/075,450

(22) Filed: Mar. 21, 2016

Related U.S. Application Data
(63) Continuation of application No. PCT/JP2014/073463, filed on Sep. 5, 2014.

(30) Foreign Application Priority Data
Sep. 30, 2013 (JP) 2013-203889

(51) Int. Cl. H01M 10/0585; H01M 10/0525; H01M 10/04; H01M 2/18; H01M 2/26

(52) U.S. Cl. CPC H01M 10/0585; H01M 2/18; H01M 2/26; H01M 10/0459; H01M 10/0525; H01M 2220/30

(57) ABSTRACT

A stacked secondary battery with having a positive electrode member and a negative electrode member. At least one of the positive electrode member and the negative electrode member is sandwiched between a pair of sheet-like separators. The pair of sheet-like separators are welded together along peripheral sections thereof in predetermined locations, and separator members adjacent to each other in a direction of stacking the positive electrode member and the negative electrode member have welded parts that do not overlap with each other when viewed in the direction of stacking.

### CROSS REFERENCE TO RELATED APPLICATIONS

The present application is a continuation of International application No. PCT/JP2014/073463, filed Sep. 5, 2014, which claims priority to Japanese Patent Application No. 2013-203889, filed Sep. 30, 2013, the entire contents of each of which are incorporated herein by reference.

### FIELD OF THE INVENTION

The present invention relates to a battery such as a lithium ion secondary battery, and more particularly, to a stacked secondary battery that has a stack structure obtained by repeatedly stacking a positive electrode member and a negative electrode member with a separator layer interposed therebetween.

### BACKGROUND OF THE INVENTION

In recent years, as power sources of portable electronic devices, e.g., cellular phones and portable personal computers, batteries (secondary batteries) have been used widely as typified by lithium ion secondary batteries.

Now, as such a battery, a stacked secondary battery has been proposed which is structured as shown in FIG. 10.

This stacked secondary battery 101 has a number of first electrodes 102, a number of first current collector tabs 105a, a number of separators 104a each able to be separated into two of a first part and a second part with respect to a central axis A, a number of second electrodes 103 each able to be separated into two parts with respect to a central axis B, one of which is opposed to the first part, whereas the other is opposed to a second part, and a number of second current collector tabs 105b.

Further, the first part for each separator 104a has a first asymmetric part 107 formed to be asymmetric to the second part with respect to the central axis A, whereas one of the parts for each second electrode 103 has a second asymmetric part 108 formed to be asymmetric to the other part with respect to the central axis B, and all of the first asymmetric parts 107 and all of the second asymmetric parts 108 are adaptively aligned in the stacking direction.

Further, sac-like separators formed by stacking sheet-like materials for separators and subjecting predetermined locations of peripheral sections to fusion splicing are used as the separator 104a, and the fusion-spliced locations 114 of the respective sheet-like materials for separators have the same locations for the respective sac-like separators 104a as viewed from the stacking direction (see FIGS. 1, 4, and 5, etc. of Patent Document 1).

The stacked secondary battery 101 configured as described above according to Patent Document 1 makes it possible to easily recognize electrodes stacked wrongly, thereby making it possible to prevent problems due to electrodes stacked wrongly, because the first asymmetric part 107 is not aligned with the second asymmetric part 108 in the stacking direction even when either the first electrode 102 or the second electrode 103 is stacked wrongly, thereby resulting in an overlap between the first current collector tab 105a and the second current collector tab 105b in the stacking direction.

Patent Document 1: Japanese Patent Application Laid-Open No. 2012-54194

### SUMMARY OF THE INVENTION

However, in the case of the stacked secondary battery in Patent Document 1 as mentioned above, the first electrode 102 or the second electrode 103 is housed in the sac-like separators 104a formed by stacking the sheet-like materials for separators and subjecting the predetermined locations of the peripheral sections to fusion splicing. The first electrodes 102 or the second electrodes 103 housed in the separators 104a are stacked alternately with the other electrodes, and the fusion-spliced parts 114 of the peripheral sections of the respective sac-like separators 104a have the same locations for the respective sac-like separators 104a as viewed from the stacking direction (see FIGS. 1, 4, and 5, etc. of Patent Document 1).

Therefore, the fusion-spliced parts 114 and vicinities thereof become larger in thickness than the other regions due to the shrinkage of the sheet-like materials for separators in the fusion-splicing, and the increased stacked numbers of the first and second electrodes 102, 103 and separators 104a increases the thickness of the stacked body at the peripheral sections with the fusion-spliced parts 114 stacked. Thus, there are problems such as electrode or separator shifts caused by warpage caused for each electrode or separator, and battery characteristics degraded due to the increased distance between the first electrode and the second electrode.

The present invention is intended to solve the problems mentioned above, and an object of the invention is to provide a highly reliable stacked secondary battery which never cause the locations of respective positive electrodes and negative electrodes or the locations of current collector tabs to vary due to the larger thicknesses of welded parts (fusion-spliced parts) of peripheral sections of separator members adjacent to each other in a stacking direction as compared with the other regions of the separator members, or never cause increase in the distance between the positive electrode and the negative electrode, thereby degrading battery characteristics.

In order to solve the problems mentioned above, a stacked secondary battery according to the present invention includes an electric storage element including a stacked structure of a positive electrode member and a negative electrode member stacked with a separator layer interposed therebetween, and an electrolyte. An exterior body houses the electric storage element. A positive electrode lead terminal is connected to a current collector tab of the positive electrode member, and partially extended externally from the exterior body. A negative electrode lead terminal is connected to a current collector tab of the negative electrode member, and partially extended externally from the exterior body.

At least one of the positive electrode member and the negative electrode member sandwiched between a pair of sheet-like separators. The pair of sheet-like separators are stacked and welded along the peripheral sections thereof in predetermined locations to form a plurality of welded parts, and the current collector tab is extended externally from the peripheral sections.

The plurality of welded parts of respective separators that are adjacent to each other in a direction of stacking of the positive electrode member and the negative electrode member, are formed in locations that have no overlap with each other when viewed from a direction of stacking.

In addition, in the battery according to the present invention, the separators are formed in a sac-like form by welding, in a number of locations, the peripheral sections of the pair of stacked sheet-like separators.

The use of a sac-like member formed by welding the peripheral sections of the stacked sheet-like separators in a number of locations makes it possible to ensure that at least one of the positive electrode member and the negative electrode member is held in the sac-like form, thereby making the present invention more effective.

However, the separator member may have any form as long as the welded separators can hold at least one of the positive electrode member and the negative electrode member, and ensure that the positive electrode member and the negative electrode member are stacked with the separator layer interposed therebetween. For example, it is also possible to adopt a shape (for example, a substantially cylindrical shape) such that the positive electrode member or the negative electrode member is held between sheet-like materials for a separator by welding a side in predetermined positions to provide the side with such an opening through which a current collector tab can be extended, and welding a side opposed to the side mentioned above in predetermined locations while at least one of the positive electrode member and the negative electrode member has a current collector tab extended from the opening. It is also possible to adopt yet other shapes, the configuration and size of which can be determined by the design of the battery.

When the stacked secondary battery according to the present invention is configured as described above, a highly reliable stacked secondary battery can be provided in which the locations of respective positive electrode members and negative electrode members or the locations of the current collector tabs do not vary due to the larger thicknesses of welded parts of the peripheral sections of separator members adjacent to each other in the stacking direction as compared with the other regions of the separator members, or never cause increase in the distance between the positive electrode member and the negative electrode member, thereby degrading battery characteristics.

### BRIEF EXPLANATION OF THE DRAWINGS

FIG. 1 is a plan view illustrating a stacked secondary battery (lithium ion secondary battery) according to an embodiment (Embodiment 1) of the present invention.

FIG. 2 is an exploded perspective view illustrating the configuration of a main part of the stacked secondary battery according to Embodiment 1 of the present invention.

FIG. 3 is an exploded perspective view illustrating a sac-like separator member and a positive electrode member housed in the separator member, in the stacked secondary battery according to Embodiment 1 of the present invention.

FIG. 4 is a plan view illustrating the locational relationship between welded parts for a pair of separator members adjacent to each other in a stacking direction, in the stacked secondary battery according to Embodiment 1 of the present invention.

FIG. 5 is a diagram illustrating the locational relationship between welded parts for separator members, in the stacked secondary battery according to Embodiment 1 of the present invention.

FIG. 6 is a diagram for explaining a method for measuring the magnitude of warpage of a stacked structure constituting a stacked secondary battery according to Embodiment 1 of the present invention.

FIG. 7 is a diagram for explaining a method for measuring the location shift of a current collector tab (positive electrode current collector tab) constituting a stacked secondary battery according to Embodiment 1 of the present invention.

FIG. 8 is a plan view illustrating the locational relationship between welded parts for three separator members adjacent to each other in a stacking direction, in a stacked secondary battery according to another embodiment (Embodiment 2) of the present invention.

FIG. 9 is a diagram illustrating the locational relationship among welded parts for separator members in a stacked secondary battery according to Embodiment 2 of the present invention.

FIG. 10 is a diagram illustrating the configuration of a conventional stacked secondary battery.

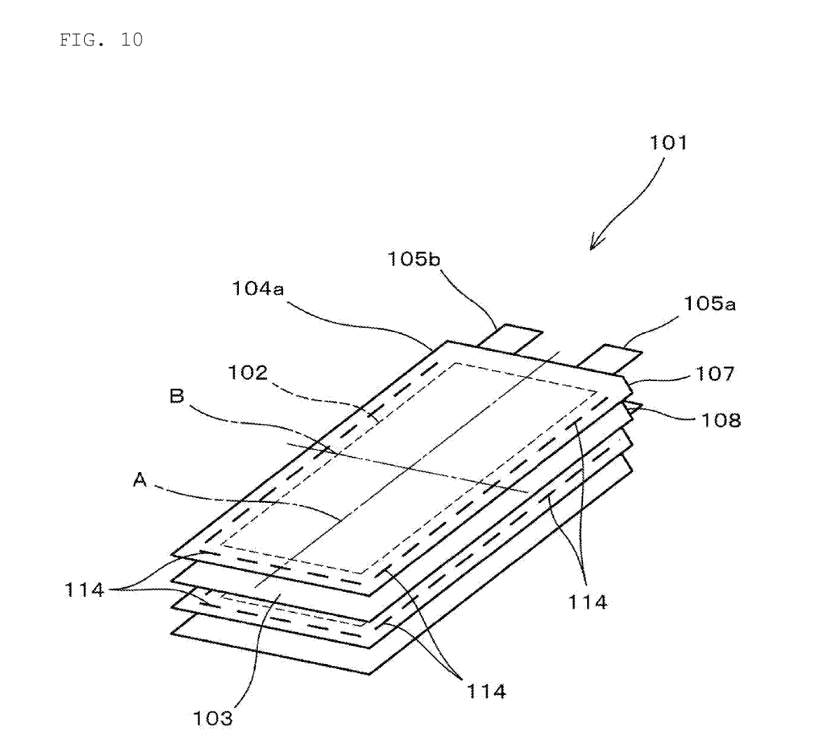

### DETAILED DESCRIPTION OF THE INVENTION

Features of the present invention will be described in more detail below with reference to embodiments of the present invention.

### Embodiment 1

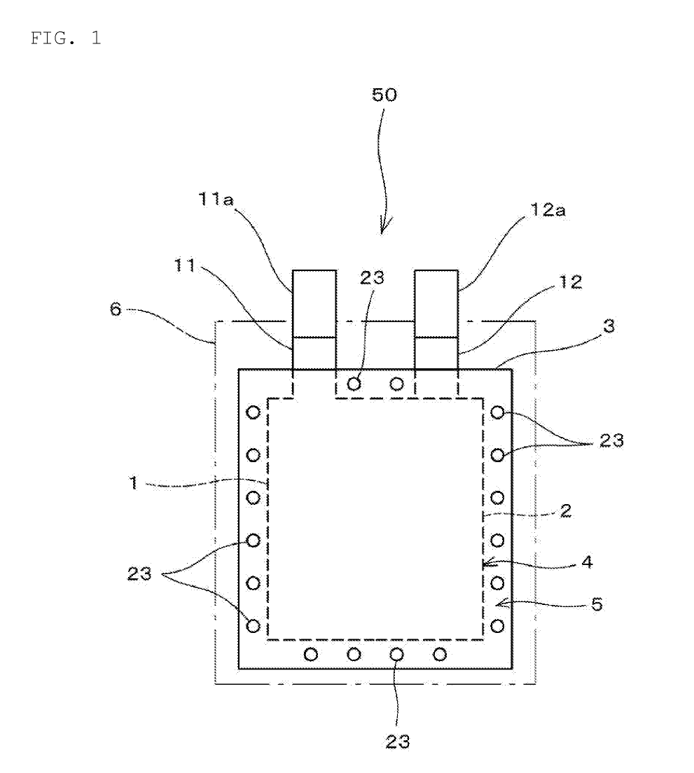

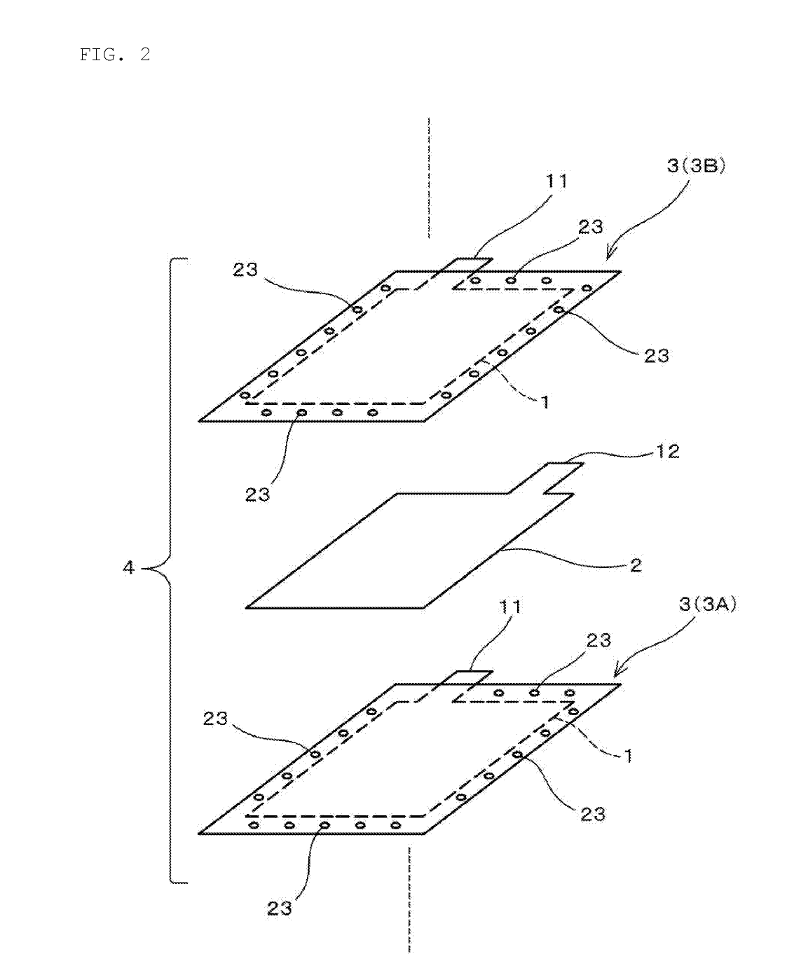

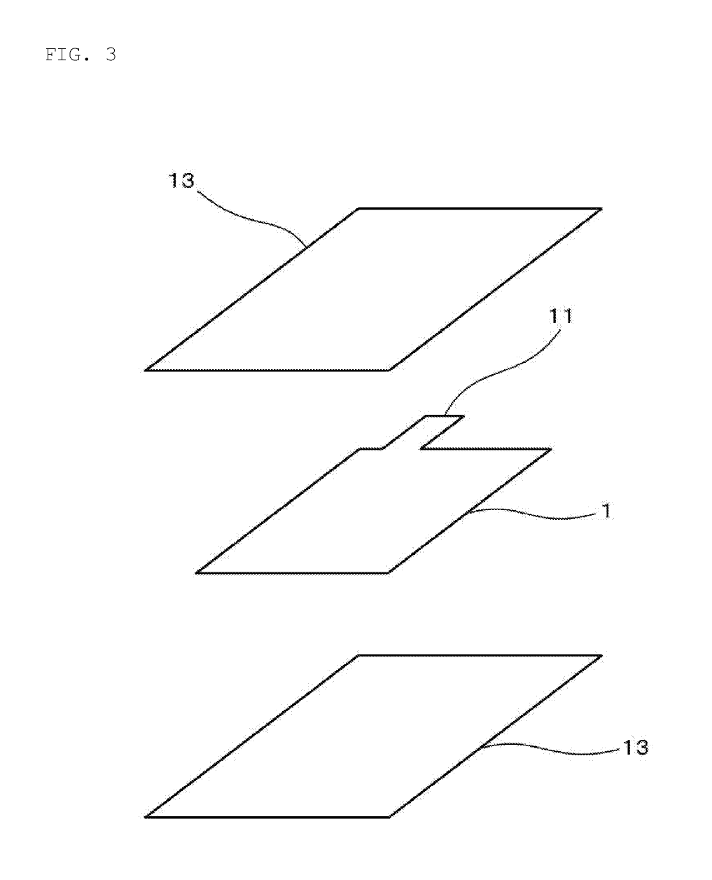

FIG. 1 is a plan view illustrating a stacked secondary battery (lithium ion secondary battery) according to an embodiment (Embodiment 1) of the present invention, FIG. 2 is an exploded perspective view illustrating the configuration of a main part of the battery, and FIG. 3 is an exploded perspective view illustrating a sac-like separator member and a positive electrode member housed in the separator member.

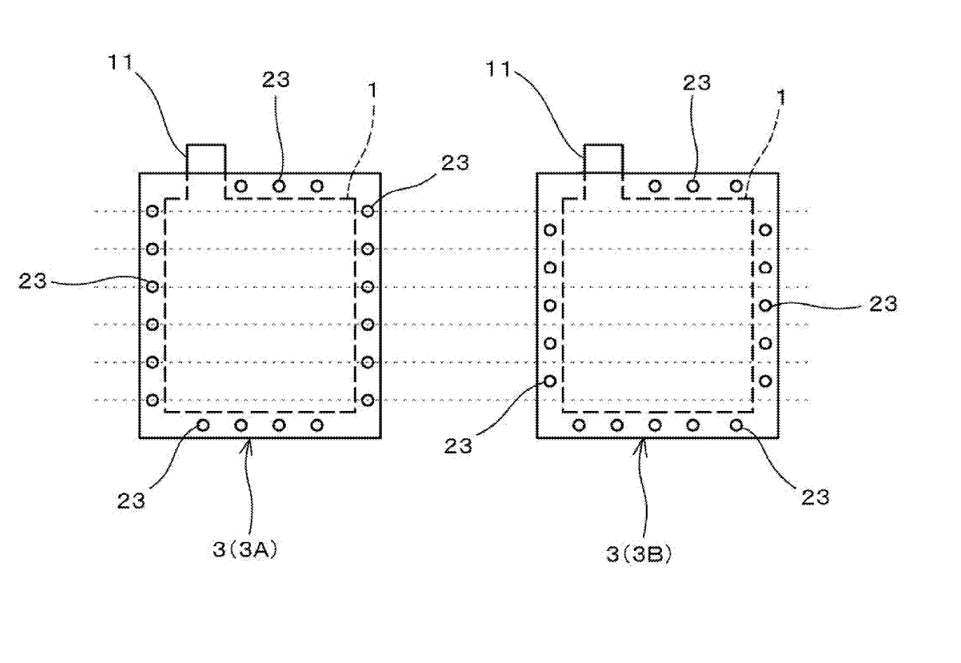

In addition, FIG. 4 is a plan view illustrating the locational relationship between welded parts for a pair of separator members adjacent to each other in a stacking direction.

The stacked secondary battery 50 according to Embodiment 1 is configured, as shown in FIGS. 1 to 4, to have a storage element 5 housed in an outer layer body 6, the element including: a stacked structure 4 where a positive electrode member 1 obtained by forming a positive electrode combination material containing a positive electrode active material on a current collector for a positive electrode and a negative electrode member 2 obtained by forming a negative electrode combination material containing a negative electrode active material on a current collector for a negative electrode are stacked with a separator layer 13 interposed therebetween; and an electrolyte (not shown).

Furthermore, a positive electrode lead terminal 11a is connected to a current collector tab (positive electrode current collector tab) 11 provided for the positive electrode member 1, with an end of the terminal extended from the exterior body 6 to the outside, and a negative electrode lead terminal 12a is connected to a current collector tab (negative electrode current collector tab) 12 provided for the negative electrode member 2, with an end of the terminal extended from the exterior body 6 to the outside.

In addition, in the stacked secondary battery 50 according to Embodiment 1 herein, the positive electrode member 1 is housed in a separator member 3 formed in a sac-like form by stacking sheet-like materials for separators 13 and welding at a predetermined number of locations along peripheral sections thereof, the separator layers (sheet-like materials for separators) 13 constituting the separator member 3. In addition, the current collector tab 11 of the positive electrode member 1 is extended from an opening of the sac-like separator member 3 to the outside.

Further, the stacked structure 4 mentioned above is formed by alternately stacking the positive electrode member 1 housed in the sac-like separator member 3 and the negative electrode member 2, and configured such that the separator layers 13 constituting the separator member 3 are interposed between the positive electrode member 1 and the negative electrode member 2.

It is to be noted that the stacked structure 4 is formed by alternately stacking sixty-seven positive electrode members 1 housed in sac-like separator members 3 and sixty-eight negative electrode members 2 in Embodiment 1 herein.

In addition, in the formation of the structure with the positive electrode member 1 housed in the sac-like separator member 3, the structure with the positive electrode member 1 housed in the sac-like separator member 3 is obtained as shown in FIG. 2 by for example, as shown in FIG. 3, locating the positive electrode member 1 between the two separator layers (sheet-like materials for separators) 13, sandwiching the positive electrode member 1 between the separator layers (sheet-like materials for separators) 13, and then welding a predetermined number of locations of peripheral sections.

Further, in the stacked secondary battery 50 according to Embodiment 1 herein, the sac-like separator members 3 (3A, 3B) adjacent to each other in the stacking direction are configured such that numbers of welded parts (fusion-spliced parts) 23 of peripheral sections of the members are located so as not to overlap with each other as viewed from the stacking direction, as shown in FIG. 4. It is to be noted that while the welded parts 23 formed at four sides of the separator members 3 are located so as not to overlap the current collector tabs 11 with each other as viewed from the stacking direction as shown in FIG. 4 in Embodiment 1 herein, it is more important to locate the welded parts 23 formed at sides perpendicular to the sides from which the current collector tabs 11 are extended, so as not to be overlapped. This is due to the fact that when the welded parts are overlapped, the parts will undergo warpage, resulting in shifts in stacking.

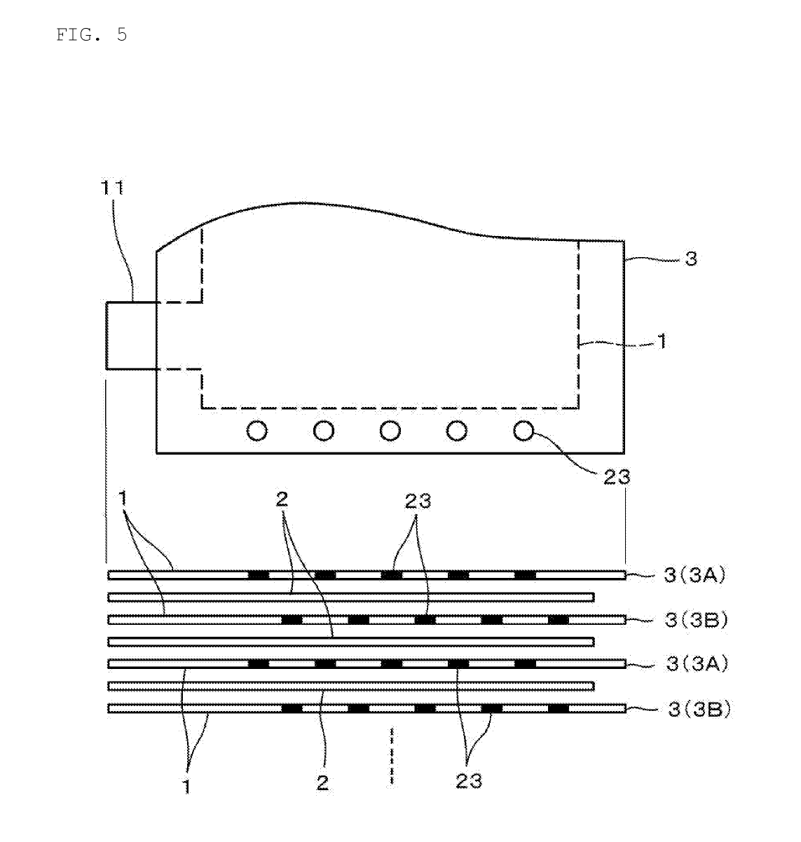

FIG. 5 is a diagram schematically illustrating alternately stacked separator members 3A, 3B that differ from each other in the locations of numbers of welded parts (fusion-spliced parts) 23 of peripheral sections, each with positive electrode members 1 housed therein, and with negative electrode members 2 interposed therebetween.

In the stacked secondary battery 50 according to Embodiment 1 herein, as shown in FIG. 5, the positions of the welded parts 23 differ between the sac-like separator members 3A, 3B adjacent to each other in the stacking direction, while the welded parts (fusion-spliced parts) 23 have the same locations every other layer because the separator members 3A and 3B are stacked alternately.

Accordingly, the number of welded parts (fusion-spliced parts) 23 overlapped is reduced to ½ in the case of the configuration according to Embodiment 1 herein, as compared with a case where separator members 3 are all identical in the locations of welded parts (fusion-spliced parts) 23.

As a result, it becomes possible to suppress warpage of the positive electrode members 1 and negative electrode members 2 (that is, warpage of the stacked structure 4), due to the increased numbers of overlapped welded parts (fusion-spliced parts) 23 of peripheral sections of the separator members 3 (3A, 3B in FIG. 4) adjacent to each other in the stacking direction.

In addition, variations can be reduced in the positions of the respective positive electrode members 1 and negative electrode members 2, the positions of the current collector tabs 11, 12, and the like, and battery characteristic degradation due to the increased distances between the positive electrode members 1 and the negative electrode members 2 can be suppressed. Then, as a result, it becomes possible to provide the highly reliable stacked secondary battery 50.

Further, warpage of the stacked structure 4 constituting the stacked secondary battery 50 according to Embodiment 1 of the present invention, and the location shift of the current collector tab (positive electrode current collector tab 11) were examined by the methods described below. It is to be noted that the stacked structure has dimensions of width W: 130 mm, thickness T: 10 mm, and length L: 130.

(1) Warpage of Stacked Structure constituting Stacked Secondary Battery

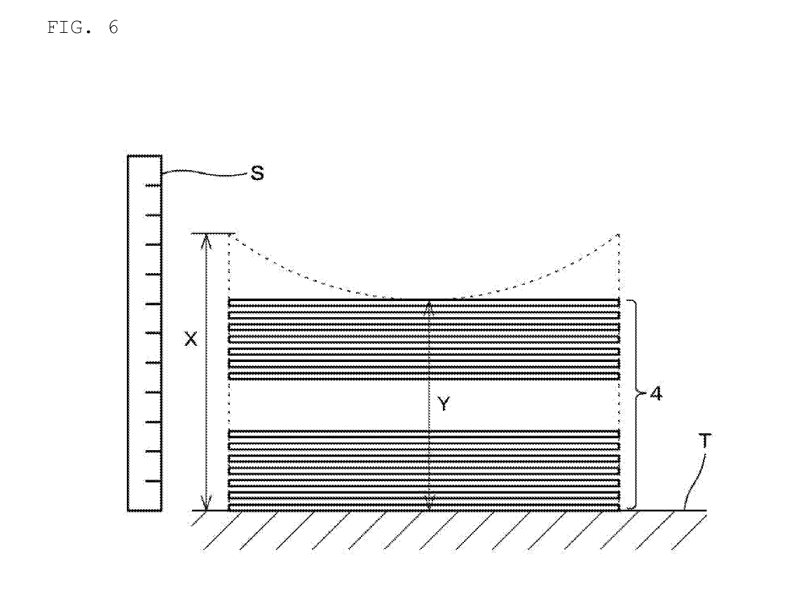

As shown in FIG. 6, the stacked structure 4 constituting the stacked secondary battery 50 according to Embodiment 1 of the present invention was placed on a table T, and the dimension X of a part with most warpage at either right or left end and a dimension Y of a central part were measured with a scale S to regard the difference (X−Y) therebetween as a warpage amount. It is to be noted that FIG. 6 is a diagram of the stacked structure 4 viewed from the direction of extending the current collector tab (positive electrode current collector tab 11).

In addition, for comparison, a stacked structure (comparative example) prepared such that separator members 3 were all identical in the locations of welded parts (fusion-spliced parts) was checked for the warpage amount by the same method as described above.

The results are shown in Table 1.

TABLE 1

| | Warpage Amount of |
|---|---|
| | Stacked Structure |
| Sample | (mm) |
| Comparative Example | 25 |
| Sample of Embodiment 1 | 22 |

As shown in Table 1, it has been confirmed that while the warpage amount is 25 mm in the case of the stacked structure of the comparative example where the separator members 3 are all identical in the locations of the welded parts, the warpage amount is reduced to 22 mm in the case of the sample (stacked structure) according to Embodiment 1 of the present invention.

(2) Location Shift of Current Collector Tab (Positive Electrode Current Collector Tab)

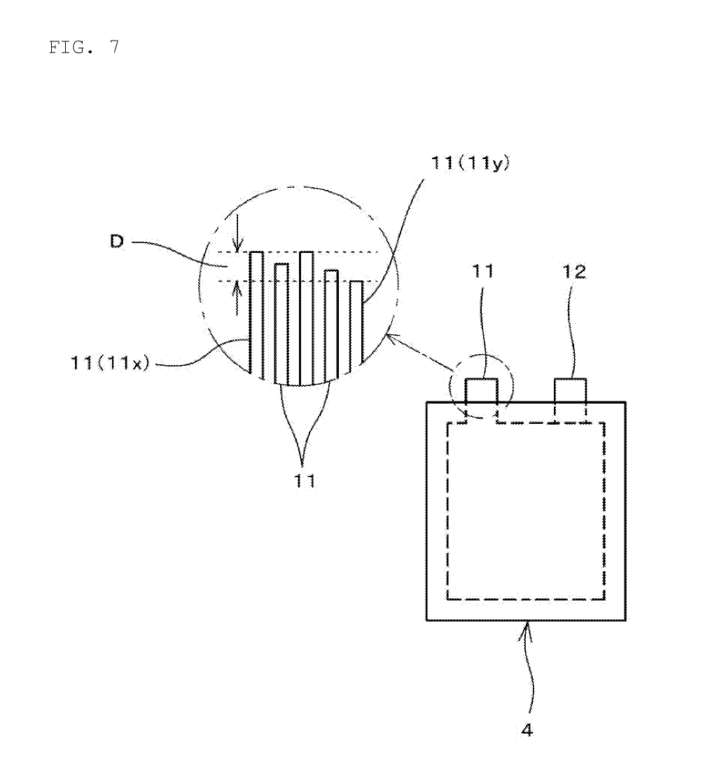

As shown in FIG. 7, among the number of current collector tabs (positive electrode current collector tabs 11), the locational difference D in the direction of extending the positive electrode current collector tabs 11 was regarded as the location shift of the positive electrode current collector tab between the end location of the most projected positive electrode current collector tab 11 (11x) and the end location of the most recessed positive electrode current collector tab 11 (11y).

In addition, for comparison, a stacked structure (comparative example) prepared in such a way that separator members 3 were all identical in the locations of welded parts (fusion-spliced parts) was also checked for the location shift of the positive electrode current collector tab by the same method as described above.

The results are shown in Table 2.

TABLE 2

| | Location Shift of |
|---|---|
| | Current Collector Tab |
| Sample | (mm) |
| Comparative Example | 1.5 |
| Sample of Embodiment 1 | 1.0 |

As shown in Table 2, it has been confirmed that while the location shift of the positive electrode current collector tab is 1.5 mm in the case of the stacked structure of the comparative example where the separator members 3 are all identical in the locations of the welded parts (fusion-spliced parts), the location shift of the positive electrode current collector tab is reduced to 1.0 mm in the case of the sample (stacked structure) according to Embodiment 1 of the present invention.

### Embodiment 2

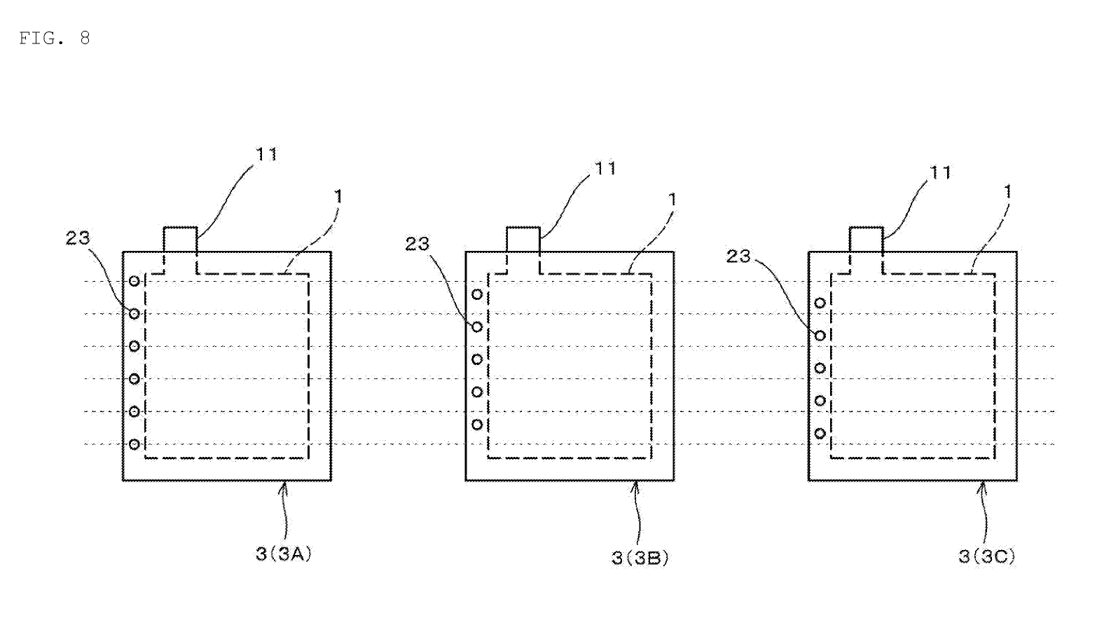

FIG. 8 is a diagram illustrating the configuration of a stacked secondary battery 50 according to another embodiment (Embodiment 2) of the present invention.

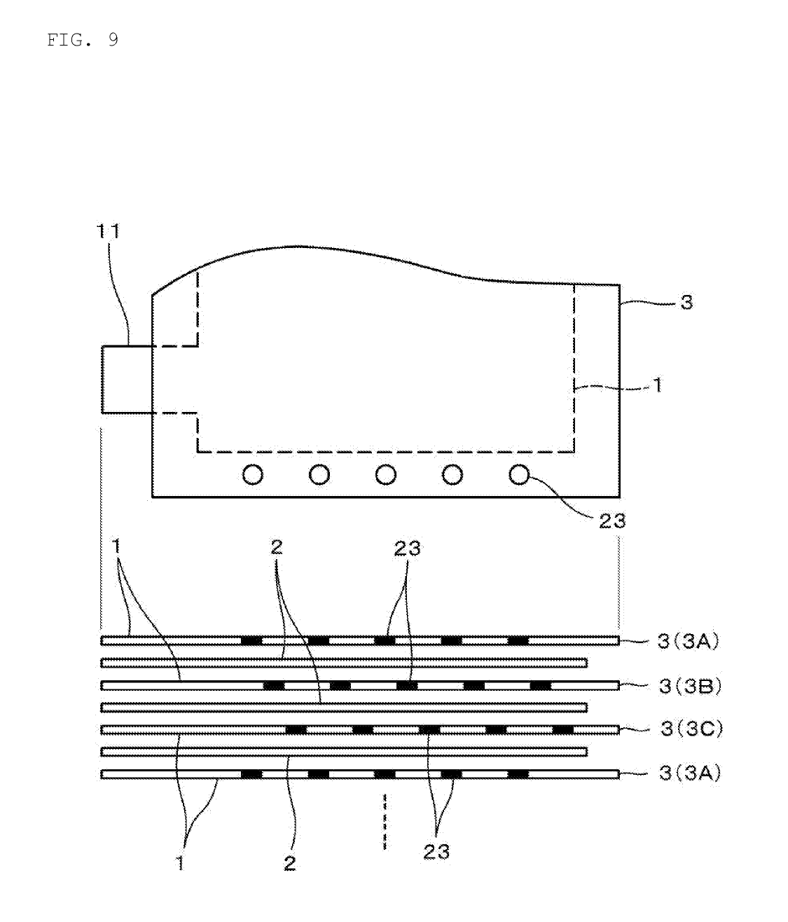

While the positive electrode members 1 housed in the two types of separators 3A, 3B that differ from each other in the locations of the number of welded parts (fusion-spliced parts) 23 of the peripheral sections are alternately stacked with the negative electrode members 2 interposed therebetween in Embodiment 1, positive electrode members 1 respectively housed in three types of separators 3A, 3B, 3C that differ from each other in the locations of a number of welded parts (fusion-spliced parts) 23 of peripheral sections are repeatedly stacked in the order of 3C, 3B, and 3A from the bottom with negative electrode members 2 interposed therebetween, thereby forming a stacked structure 4 as shown in FIG. 8 in Embodiment 2 herein (see FIG. 9).

It is to be noted that while FIG. 8 only shows the welded parts 23 provided at one side for the three types of separators 3A, 3B, 3C, and omits the illustration of welded parts at the other sides, the welded parts are similarly formed also at the other sides in locations that differ from each other.

Further, FIG. 9 is a diagram schematically illustrating the positive electrode members 1 housed respectively in the separators 3A, 3B, 3C that differ from each other in the locations of the number of welded parts (fusion-spliced parts) 23 of the peripheral sections, which are stacked repeatedly in the order of 3C, 3B, 3A with the negative electrode members 2 interposed therebetween.

As shown in FIG. 9, in the stacked secondary battery 50 according to Embodiment 2, the sac-like separator members 3A, 3B, 3C adjacent to each other in the stacking direction differ from each other in the locations of the welded parts 23, and the three types of separator members 3C, 3B, 3A differ in the locations of the welded parts 23 are stacked in this order, and then, the three types of separator members 3C, 3B, 3A are stacked again in this order.

Accordingly, the number of welded parts (fusion-spliced parts) 23 overlapped is reduced to ⅓ in the case of the configuration according to Embodiment 2 herein, as compared with a case where separator members 3 are all identical in the locations of welded parts (fusion-spliced parts) 23.

As a result, it becomes possible to suppress warpage of the positive electrode members 1 and negative electrode members 2 (that is, warpage of the stacked structure 4), due to the increased numbers of overlapped welded parts (fusion-spliced parts) 23 of peripheral sections of the separator members 3 (3A, 3B, 3C in FIG. 9).

In addition, variations can be reduced in the positions of the respective positive electrode members 1 and negative electrode members 2, the positions of the current collector tabs 11, 12, and the like, and battery characteristic degradation due to the increased distances between the positive electrode members 1 and the negative electrode members 2 can be suppressed. Then, as a result, it becomes possible to provide the highly reliable stacked secondary battery 50.

Further, for the stacked secondary battery 50 according to Embodiment 2 of the present invention, warpage of the stacked structure 4 constituting the battery and the location shift of the current collector tab (positive electrode current collector tab 11) were also checked in the same way as in the case of Embodiment 1 described above.

Table 3 shows therein the results of checking the magnitude of warpage of the stacked structure 4.

TABLE 3

| | Warpage Amount of |
|---|---|
| | Stacked Structure |
| Sample | (mm) |
| Comparative Example | 25 |
| Sample of Embodiment 2 | 20 |

In addition, Table 4 shows therein the results of checking the location shift of the current collector tab (positive electrode current collector tab 11).

TABLE 4

| | Location Shift of |
|---|---|
| | Current Collector Tab |
| Sample | (mm) |
| Comparative Example | 1.5 |
| Sample of Embodiment 2 | 0.8 |

As shown in Table 3, it has been confirmed that while the warpage amount is 25 mm in the case of the stacked structure of the comparative example where separator members 3 are all identical in the locations of welded parts (fusion-spliced parts), the warpage amount is reduced to 20 mm in the case of the sample (stacked structure) according to Embodiment 2 of the present invention.

In addition, as shown in Table 4, it has been confirmed that while the location shift of the positive electrode current collector tab is 1.5 mm in the case of the stacked structure of the comparative example where the separator members 3 are all identical in the locations of the welded parts (fusion-spliced parts), the location shift of the positive electrode current collector tab is reduced to 0.8 mm in the case of the sample (stacked structure) according to the embodiment of the present invention.

While a case where the positive electrode members are housed in the sac-like separator members has been explained as an example in Embodiments 1 and 2 described above, it is also possible to adopt a configuration such that the negative electrode members are housed in the sac-like separator members in some cases.

In addition, while a case where the separator members have a sac-like shape has been explained as an example in Embodiments 1 and 2 described above, it is not always necessary for the separator members to have a sac-like shape, but what is required is just being capable of holding at least one of the positive electrode members or negative electrode members between the separator layers.

In addition, while the positive electrode member 1 is formed by welding the predetermined locations of the peripheral sections of the two separator layers (sheet-like materials for separators) in the embodiment described above, the positive electrode member 1 may be formed by folding one separator layer (sheet-like material for separators) in half and welding predetermined locations of a peripheral section.

The present invention is further not limited to the embodiments described above in other respects, various applications and modifications can be made within the scope of the invention in regard to the numbers of positive electrode members and negative electrode members stacked, the directions of extending the current collector tabs, etc.

### DESCRIPTION OF REFERENCE SYMBOLS

1: positive electrode member

2: negative electrode member

3: separator member

3A, 3B, 3C: separator members that differ in welded part location

4: stacked structure

5: electric storage element

6: exterior body

11: current collector tab (positive electrode current collector tab)

11a: positive electrode lead terminal

11x: positive electrode current collector tab located to be most projected

11y: positive electrode current collector tab located to be most recessed

12: current collector tab (negative electrode current collector tab)

12a: negative electrode lead terminal

13: separator layer (sheet-like material for separator)

23: welded part (fusion-spliced part)

50: stacked secondary battery

D: location shift of current collector tab

S: scale

T: table

X: dimension of part with most warpage at either right or left end of stacked structure

Y: dimension of central part of stacked structure

1.-2. (canceled)

3. A stacked secondary battery comprising:
an electric storage element comprising:
a positive electrode member having a positive current collector tab;
a negative electrode member having a negative current collector tab;
a pair of separators sandwiching at least one of the positive electrode member and the negative electrode member, the pair of separators having welded parts along peripheral sections thereof, the welded parts joining the pair of separators together to form a separator member, and wherein the welded parts of respective separator members that are adjacent to each other in a direction of stacking of the positive electrode member and the negative electrode member are positioned so as to not overlap with each other when viewed in the direction of stacking; and
an electrolyte;
an exterior body housing the electric storage element;
a positive electrode lead terminal connected to the positive current collector tab, and partially extended externally from the exterior body; and
a negative electrode lead terminal connected to the negative current collector tab, and partially extended externally from the exterior body.

4. The stacked secondary battery according to claim 3, wherein the separator member is in a sac form, and the peripheral sections of the pair of stacked separators have a plurality of the welded parts throughout the peripheral sections.

5. The stacked secondary battery according to claim 3, wherein the pair of separators sandwich the positive electrode member and the positive current collector tab extends externally from the peripheral sections of the separator member.

6. The stacked secondary battery according to claim 5, wherein the welded parts do not overlap the positive current collector tab.

7. The stacked secondary battery according to claim 3, wherein the pair of separators sandwich the negative electrode member and the negative current collector tab extends externally from the peripheral sections of the separator member.

8. The stacked secondary battery according to claim 7, wherein the welded parts do not overlap the negative current collector tab.

9. The stacked secondary battery according to claim 3, wherein the welded parts of at least three separator members that are consecutive to each other in a direction of stacking of the positive electrode member and the negative electrode member are positioned so as to not overlap with each other when viewed in the direction of stacking.
